(19) United States
(12) Patent Application Publication
(10) Pub. No.: US 2006/0261763 A1
(43) Pub. Date: Nov. 23, 2006

(54) Brushed motor position control based upon back current detection

(75) Inventors: Jeffrey Iott, Monroe, MI (US); David Burke, Taylor, MI (US)

Correspondence Address: CARLSON, GASKEY & OLDS, P.C., 400 WEST MAPLE ROAD, SUITE 350, BIRMINGHAM, MI, 48009, US

(73) Assignee: Masco Corporation

(21) Appl. No.: 11/134,925

(22) Filed: May 23, 2005

(51) Int. Cl. H02P 7/06

(52) U.S. Cl. 318/138

(57) ABSTRACT

Brushed DC electric motors have a rotor with commutator portions moving into and out of contact with brushes. As each of these contacts end, a back EMF force is induced into a main current supply signal. The number of these periodic forces can be counted and utilized to identify the position of the component being rotated by the DC electric motor. This method is relatively insensitive to environmental changes, and thus more accurate than the existing art.

### BACKGROUND OF THE INVENTION

This application relates to a method of monitoring the position of a component driven by a DC brushed electric motor, which counts a periodic back electromotive force.

DC motors are utilized in various industries to drive any number of components between different positions. As one volume application, DC motors are utilized in automotive applications to move windows, etc. For a number of reasons, the position of the component driven by the electric motor is desirably detected. The end of travel position must be detected such that current flow to the motor can be stopped. In motors utilized in automotive application, the motor current to the windows is monitored. The motor current would increase at the end of travel position of a window, for example. Motor current is a function of torque, which would increase when the window reaches it end of travel position.

Unfortunately, motor current and torque can vary greatly based upon age of the component and motor, and based upon environmental issues such as heat or dust. The use of the known motor controls may result in a false stopping of current because higher torque levels are reached prematurely.

Further, the use of electric motors in some applications, and in particular for driving valves for water, can result in heating of the components. The flow of hot water, as an example, could result in changing torque, such that the motor current is read inaccurately as to end of travel position. In addition, these known controls would not provide good indication of the motor reaching some intermediate position for an application, which would desirably be able to stop the component at a plurality of positions.

DC motors may utilize a brush, or may be brushless. In brushless motors, a technique for determining position is known wherein a back EMF force is counted. However, this method has not been utilized in brushed DC motors.

### SUMMARY OF THE INVENTION

In a disclosed embodiment of this invention, a back EMF current generated by a brushed electric motor is identified. Applicant has discovered that with each rotation of the motor rotor, as the brushes and commutator move out of engagement, a “ripple” or back EMF force is induced into the motor current. This small ripple can be isolated, or filtered out, of the overall current signal, and counted. By counting the number of occasions of this periodic “ripple,” the present invention is able to provide a very accurate indication of then number of rotations of the rotor, and hence the position of the component. This method is relatively insensitive to environmental changes. Also, the present invention is capable of stopping a motor precisely at any number of intermediate locations.

These and other features of the present invention can be best understood from the following specification and drawings, the following of which is a brief description.

### BRIEF DESCRIPTION OF THE DRAWINGS

FIG. 1 is a schematic view of a fluid valve driven by an electric motor.

FIG. 2 schematically shows the motor rotor having commutator portions moving into and out of contact with the motor brushes.

FIG. 3 is a current versus time graph for the power current being delivered to the electric motor of FIG. 2.

FIG. 4 shows a filtered back EMF signal that is identified from the overall motor current of FIG. 3.

FIG. 5 is a view of one embodiment for the control circuitry.

### DETAILED DESCRIPTION OF THE PREFERRED EMBODIMENT

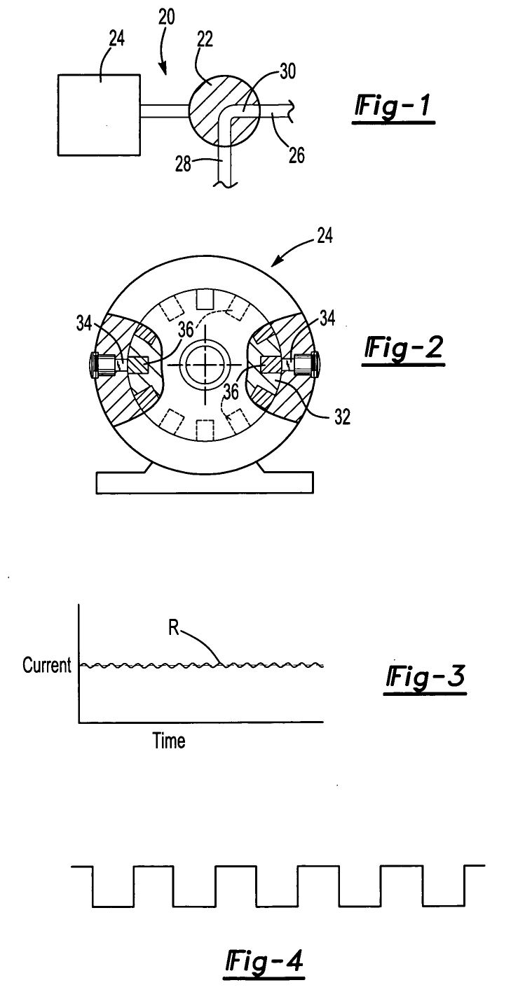

An electric motor-driven water valve system 20 is illustrated in FIG. 1 highly schematically. As shown, a valve 22 can be rotated by a brushed DC electric motor 24. The valve 22 has a path 30 that selectively communicates a water supply 26 to a downstream user line 28. As the valve 22 is rotated, more and more of the flow path 30 communicates the inlet 26 to the outlet 28. The valve can be rotated to a fully blocked flow position and to a fully open position. Moreover, the valve can be moved to any number of intermediate locations. The valve is shown schematically, and any number of rotary valves are known in the art to provide this basic function.

FIG. 2 shows a known feature of brushed DC electric motors, which would be true of the brushed DC electric motor 24. As shown, a rotor 32 is driven to rotate by a current induced in a surrounding stator. Brushes 34 periodically contact a commutator portion 36 on the rotor 32. The brushes serve to communicate an electric current to the rotor 32, such that the polarity of the rotor 32 can be reversed, and such that the rotor will be driven to rotate. This structure is shown highly schematically and is provided in any number of different ways in DC motor technology.

Applicant has discovered that as the brushes 34 move out of contact with the commutators 36, a small ripple R is induced in a main motor current supply signal as shown in FIG. 3. The ripple R is relatively small compared to the overall magnitude of the current supply, and is essentially a back EMF disturbance on the main current supply.

Applicant filters the main current supply signal, and isolates this back EMF force into a series of square waves such as shown in FIG. 4. A control 25 for the motor 24 counts these square waves, and by counting the square waves, has a very precise understanding of the position of the valve 22. The control 25 can utilize this information to provide an indication of when to stop current supply when the valve is at its end of travel position, and can also utilize this information to stop the valve 22 at any number of intermediate locations.

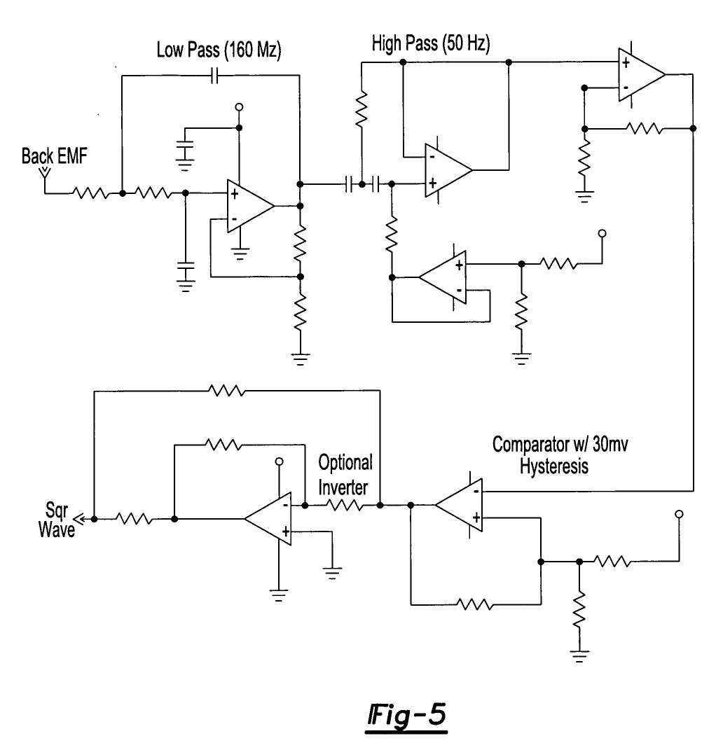

FIG. 5 shows one example control circuit. As shown, a low pass filter and a high pass filter are placed in serial connection with a comparator. The output is the square wave such as illustrated in FIG. 4. This output can be sent to some counting circuitry, which can use the counted square waves to identify the position of the motor rotor and hence the valve.

The present invention thus provides a very simple way of identifying the position of a brushed DC electric motor driven component. The method can be included into off-the-shelf existing motors, and is relatively insensitive to environmental changes.

Although a preferred embodiment of this invention has been disclosed, a worker of ordinary skill in this art would recognize that certain modifications would come within the scope of this invention. For that reason, the following claims should be studied to determine the true scope and content of this invention.

1. A DC electric motor driving a water valve to rotate comprising:
a DC electric motor including a rotor having at least one commutator portion and at least one brush for selectively communicating electrical signals through said commutator portion;
a current supply to said DC electric motor, and there being disturbances in a current supply signal from said current supply as said brush moves into and out oF contact with said commutator portion, a control being operable to count the disturbances in said current supply signal, and utilize said counted disturbances to predict a position of said water valve;
said water valve may be moved by said DC electric motor between full open, full closed, and intermediate positions, and said predicted position of said water valve being utilized to stop said water valve at a desired intermediate position; and
said predicted position also being utilized to stop said water valve at full open and full closed positions.

2. (canceled)

3. The DC electric motor and water valve as set forth in claim 1, wherein said control also includes a low pass filter, a high pass filter and a comparator in series to isolate the disturbances from the current supply signal.

4. A method of identifying the position of a rotated water valve comprising the steps of:
utilizing a brushed DC electric motor to rotate a water valve;
monitoring a current supply signal being delivered to said DC electric motor;
counting periodic disturbances in said current supply signal caused as brushes move into and out of contact with a commutator portion;
associating the number of identified periodic disturbances with a predicted position of said water valve;
said water valve may be moved by said DC electric motor between full open, full closed, and intermediate positions, and said predicted position of said water valve being utilized to stop said water valve at a desired intermediate position; and
said predicted position also being utilized to stop said water valve at full open and full closed position.

5-8. (canceled)
